(19) United States
(12) Patent Application Publication
(10) Pub. No.: US 2005/0069257 A1
(43) Pub. Date: Mar. 31, 2005

(54) Fiber lens with multimode pigtail

(76) Inventors: Venkata A. Bhagavatula, Big Flats, NY (US); John Himmelreich, Horseheads, NY (US); Phyllis J. Markowski, Lindley, NY (US); Michael H. Rasmusen, Millport, NY (US); Nagaraja Shashidhar, Painted Post, NY (US); Luis A. Zenteno, Painted Post, NY (US)

Correspondence Address: CORNING INCORPORATED, SP-TI-3-1, CORNING, NY, 14831, US

(21) Appl. No.: 10/948,995

(22) Filed: Sep. 23, 2004

Related U.S. Application Data
(60) Provisional application No. 60/506,028, filed on Sep. 25, 2003.

(51) Int. Cl. G02B 6/32

(52) U.S. Cl. 385/33

(57) ABSTRACT

A fiber lens includes a multimode fiber and a refractive lens disposed at an end of the multimode fiber. The refractive lens focuses a beam from the multimode fiber into a diffraction-limited spot. In one embodiment, a graded-index is interposed between the multimode fiber and the refractive lens. In one embodiment, the combination of the graded-index and the refractive lens enables extreme anamorphic lens characteristics.

### BACKGROUND OF THE INVENTION

The invention relates generally to optical devices for coupling optical signals between optical components. More specifically, the invention relates to a fiber lens for coupling signals between optical components and to a method of making the fiber lens.

Various approaches are used in optical communications to couple optical signals between optical components, such as optical fibers, laser diodes, and semiconductor optical amplifiers. One approach involves the use of a fiber lens, which is a monolithic device having a lens disposed at one end of a pigtail fiber. Light can enter or exit the fiber lens through either the lens or the pigtail fiber. For efficient coupling of signals between optical components having different mode fields, it is desirable that the fiber lens has the ability to transform mode fields, e.g., from one size to another and/or from one shape to another. A fiber lens that is capable of transforming circular mode fields to elliptical mode fields and vice versa is referred to as anamorphic. Another desirable characteristic of the fiber lens is the ability to focus light from the pigtail fiber into a spot having the required size and intensity at a selected working distance. Examples of such applications include coupling of optical signals from a wide stripe multimode laser diode to an optical fiber, from a high-index semiconductor or dielectric waveguide to an optical fiber, etc.

There is a desire for a fiber lens that can produce a focused beam with a small spot size and the required intensity for a broad range of working distances. The fiber lens could be anamorphic to enable efficient coupling of signals between optical components with different mode fields and aspect ratios, i.e., elliptical shapes.

### SUMMARY OF THE INVENTION

In one aspect, the invention relates to a fiber lens which comprises a multimode fiber and a refractive lens disposed at an end of the multimode to focus a beam from the multimode fiber into a diffraction-limited spot.

In another aspect, the invention relates to a fiber lens which comprises a multimode fiber, a graded-index lens disposed at an end of the multimode fiber, and a refractive lens disposed at an end of the graded-index lens, remote from the multimode fiber, to focus a beam from the multimode fiber into a diffraction-limited spot.

In another aspect, the invention relates to a fiber lens which comprises a multimode fiber, at least a spacer rod and a graded-index lens disposed at an end of the multimode fiber, and a refractive lens disposed at an end of the graded-index lens, remote from the multimode fiber, to focus a beam from the multimode fiber into a diffraction-limited spot.

In yet another aspect, the invention relates to a method of making a fiber lens which comprises cutting a first fiber to a desired length, forming a wedge at a tip of the first fiber, the wedge having a cross-sectional shape in a first plane of the first fiber that is defined by asymptotes of a hyperbola, and rounding a tip of the wedge to form a hyperbolic shape. In one embodiment, a radius of curvature of the hyperbolic shape is adjusted to form a near-hyperbolic shape having a correction factor that compensates for beam curvature.

These and other features and advantages of the invention will be discussed in more detail in the following detailed description of the invention and in conjunction with the following figures.

### BRIEF DESCRIPTION OF THE DRAWINGS

The invention is illustrated by way of example, and not by way of limitation, in the figures accompanying the drawings, and in which like reference numerals refer to similar elements, and in which:

FIG. 1A is a schematic of a fiber lens according to one embodiment of the invention.

FIG. 1B is a schematic of a fiber lens according to another embodiment of the invention.

FIG. 1C is a cross-section of a GRIN lens according to one embodiment of the invention.

FIG. 1D is a cross-section of a GRIN lens according to another embodiment of the invention.

FIG. 1E is a geometrical representation of a hyperbolic lens.

FIG. 1F is a side view of a fiber lens according to an embodiment of the invention.

FIG. 1G is a top view of the fiber lens of FIG. 1F according to one embodiment of the invention.

FIG. 1H is a top view of the fiber lens of FIG. 1F according to another embodiment of the invention.

FIG. 1I is an example of a fiber lens application for coupling light from a wide stripe laser diode.

FIG. 2A is a geometrical representation of a planar beam wavefront and a diverging beam wavefront.

FIG. 2B is a schematic of changes to be made to a hyperbolic shape to form a near-hyperbolic lens.

FIGS. 3A-3D show various shapes of core and cladding for multimode pigtail according to an embodiment of the invention.

FIG. 4A shows bundling of pigtail fibers having the cross-section shown in FIG. 3C.

FIG. 4B shows bundling of pigtail fibers having circular cross-section.

FIGS. 5A-5C illustrate a process of making a pigtail fiber according to an embodiment of the invention.

FIGS. 6A-6F illustrate a process of making a fiber lens according to an embodiment of the invention.

### DETAILED DESCRIPTION OF THE PREFERRED EMBODIMENTS

The invention will now be described in detail with reference to a few preferred embodiments, as illustrated in the accompanying drawings. In the following description, numerous specific details are set forth in order to provide a thorough understanding of the invention. It will be apparent, however, to one of ordinary skill in the art that the invention may be practiced without some or all of these specific details. In other instances, well-known process steps and/or features have not been described in detail to avoid unnecessarily obscuring the invention. The features and advantages of the invention may be better understood with reference to the drawings and the following discussions.

In accordance with the invention, a fiber lens includes a multimode pigtail fiber and a refractive lens, which is either hyperbolic or near-hyperbolic in shape. The hyperbolic lens focuses a collimated beam, i.e., a beam having a planar wavefront, to a diffraction-limited spot, and the near-hyperbolic lens focuses a non-collimated beam to a diffraction-limited spot. The near-hyperbolic lens combines the functions of a hyperbolic lens and a spherical lens, using the spherical lens function to compensate for distortion due to beam curvature.

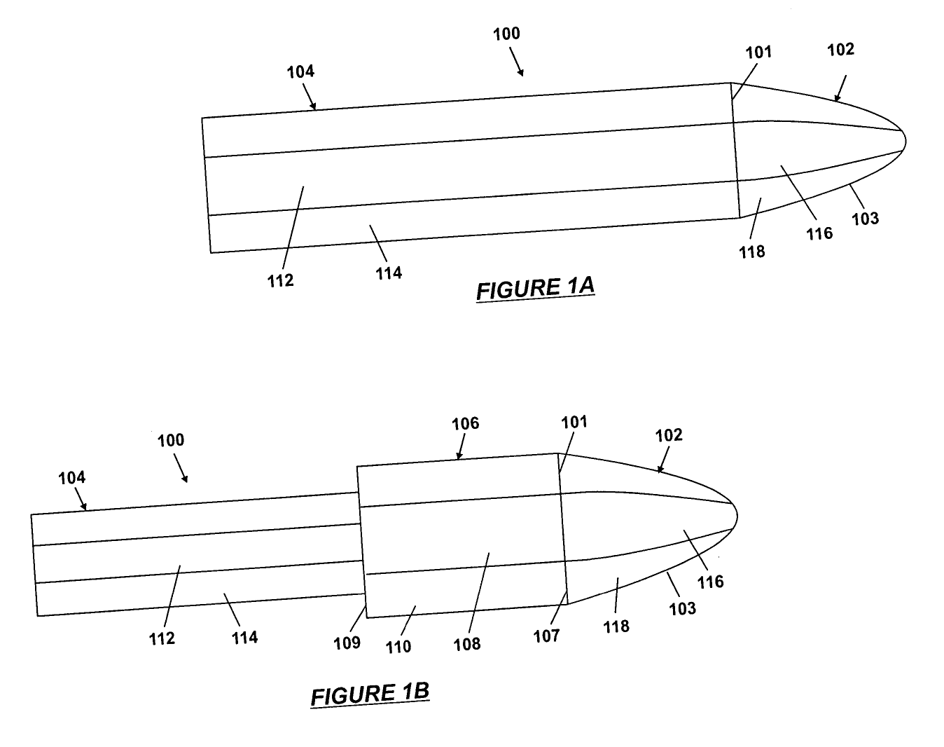

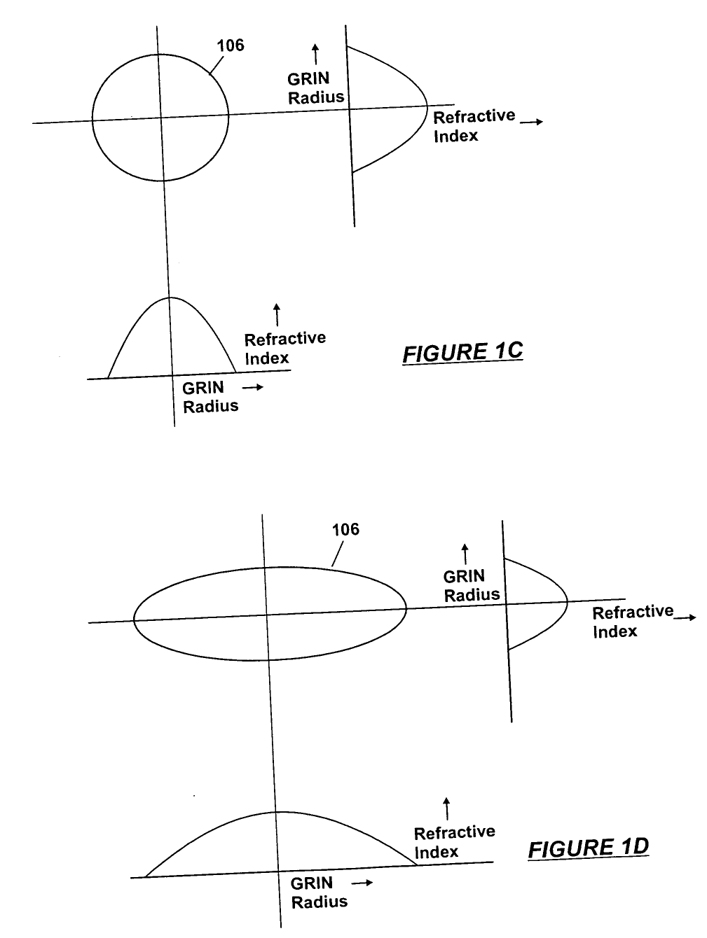

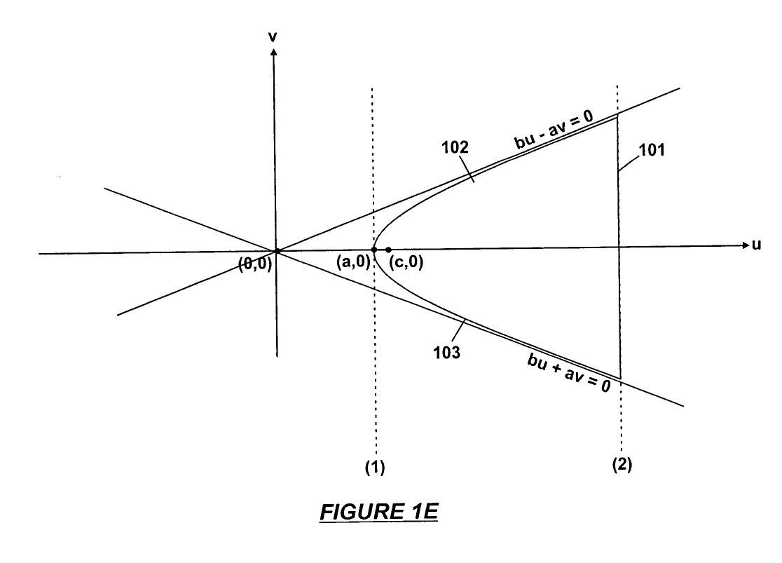

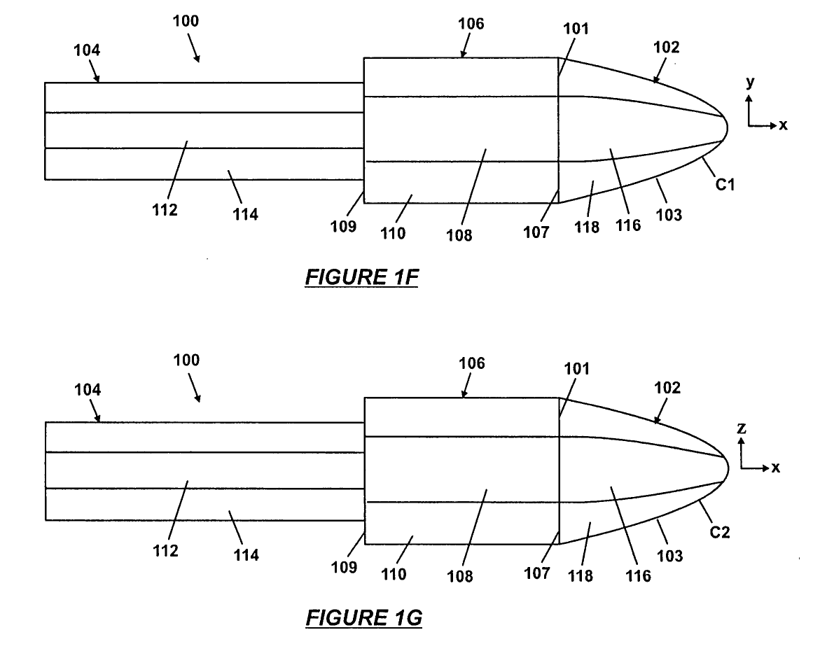

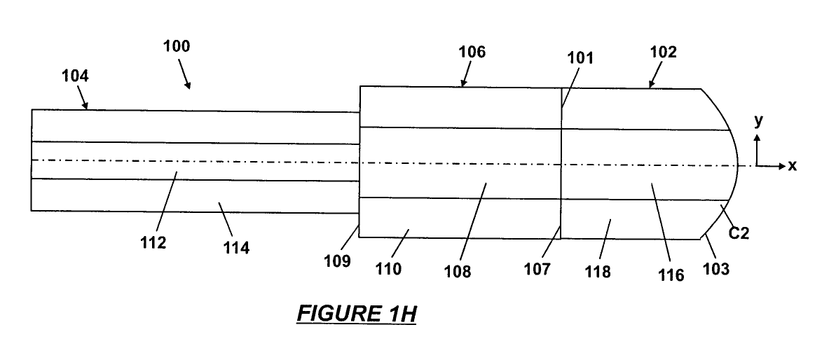

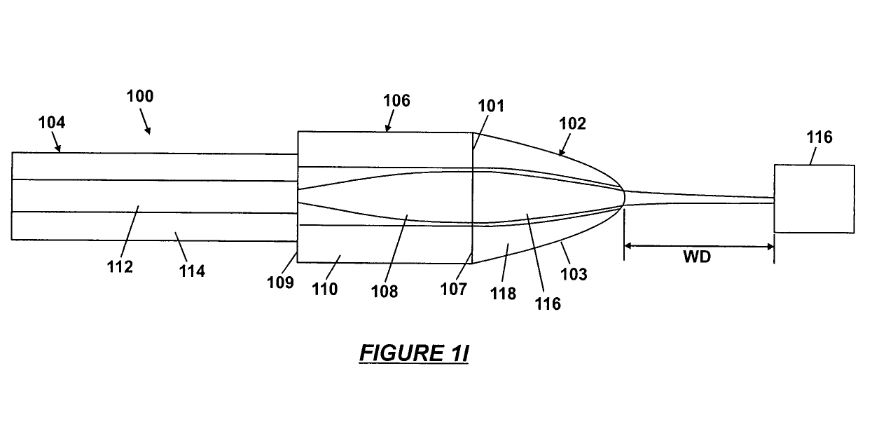

In one embodiment of the invention, as shown in FIG. 1A, a fiber lens 100 includes a refractive lens 102 disposed at an end of a multimode pigtail fiber 104. In another embodiment of the invention, as shown in FIG. 1B, the fiber lens 100 also includes a graded-index (GRIN) lens 106 interposed between the refractive lens 102 and the multimode pigtail fiber 104. The components making up the fiber lens 100 are preferably fused together to form a monolithic device. With careful control of the shape of the refractive lens 102 and the multimode parameters of the GRIN lens 106 and/or pigtail fiber 104, the fiber lens 100 can generate a focused spot that matches the output from a source such as broad area laser diode thus enabling efficient light coupling.

The GRIN lens 106 is made from a GRIN multimode fiber having a core 108 that may or may not be bounded by a cladding 110. Although not shown in the drawings, the GRIN lens 106 may be tapered. The core 108 of the GRIN lens 106 preferably has a refractive index profile that decreases radially from the optical axis toward the cladding 110. For example, the refractive index profile of the GRIN lens 106 could be parabolic or square law. The GRIN lens 106 has planar end faces 107, 109 since it is the lens medium, rather than the air-lens interface, that bends or deflects the path of light. When viewed from either the end face 107 or 109, the GRIN lens 106 may have a circular cross-sectional shape or may have other cross-sectional shape appropriate for the target application. In one embodiment, the GRIN lens 106 has a cross-sectional shape with an aspect ratio in a range from 1 to 10. FIG. 1C shows the GRIN lens 106 having a circular cross-sectional shape along with variation of the refractive index profile as a function of GRIN radius along the x- and y-axes. FIG. 1D shows a GRIN lens 106 having an elliptical cross-sectional shape along with variation of the refractive index profile as a function of GRIN radius along the x- and y-axes.

Returning to FIG. 1B, if the length of the GRIN lens 106 is quarter pitch, the beam at the end face 107 of the GRIN lens 106 would have a planar wavefront. On the other hand, if the length of the GRIN lens 106 is shorter or longer than quarter pitch, the beam at the end face 107 of the GRIN lens 106 would be diverging or converging, respectively. The formula for quarter pitch, Q, is given by:

$$Q = \frac{L}{4} = \frac{π \cdot a}{2 \cdot ( {( 2. Δ )}^{1 / 2} )} \qquad ( 1 a )$$

where
Δ=(n₁²−n₂²)/(2·n₁²) (1b)
where L is pitch, n₁ is refractive index of the core of GRIN lens, n₂ is the refractive index of the cladding of the GRIN lens, and Δ is the relative index difference between the core and cladding of the GRIN lens.

The GRIN lens 106 may be drawn from a GRIN blank (not shown) having the required dimensions and index difference and profile. The range of core diameters of the GRIN lens is preferably in a range form about 50 to 500 μm with outside diameters in a range from about 60 to 1,000 μm. The relative index difference values are preferably in a range from about 0.5 to 3% in high silica compositions compatible with splicing to fibers used in optical communication systems. In accordance with the present invention, the length of the GRIN lens 106 may be designed at or close to quarter pitch or can be different than the quarter pitch when necessary. In accordance with the present invention, multiple GRIN lenses with the same refractive index profile may be drawn from the same blank. Because the refractive index profile of the blank need not be changed, the blank making process and GRIN lens making process may be simplified. Accordingly, the same blank can be used for different mode-transforming applications. The blank may be redrawn to different outside diameters for different applications, and the resulting GRIN lens may be cut or cleaved to different lengths to meet the requirements for the different applications. This approach reduces manufacturing costs.

Referring to FIGS. 1A and 1B, the refractive lens 102 is made from an optical fiber having a core 116 that may or may not be surrounded by a cladding 118. Ideally, the refractive lens core 116 has a uniform refractive index, but it may be more convenient to form the refractive lens 102 directly on the end of the GRIN lens 106 (as in FIG. 1B) or the multimode pigtail fiber 104 (as in FIG. 1A), in which case the refractive lens core 116 may have a non-uniform refractive index. The refractive lens 102 has a substantially planar end face 101 and a curved surface 103. In one embodiment, in at least one plane of the fiber lens, the curved surface 103 has a hyperbolic shape, which can be expressed as follows:

$$\frac{{u}^{2}}{{a}^{2}} - \frac{{v}^{2}}{{b}^{2}} = 1 \qquad ( 2 a )$$

FIG. 1E is a graphical representation of the expression above. The hyperbolic refractive lens 102 is a branch of a hyperbola on a u-v coordinate system, and the vertex of the hyperbola branch lies on the u-axis at (a,0). The focus of the hyperbola branch is at (c, 0), where c is given by:
c=\sqrt{a²+b²} (2b)

The hyperbola branch is contained within two asymptotes, which are given by:
bu±av=0 (2c)

The slopes of the asymptotes are +b/a and −b/a The asymptotes intersect at the origin (0,0) to form a wedge having an apex angle, α, which is given by:
α=2 tan⁻¹(b/a) (2d)

According to Edwards et al., for an ideal hyperbolic shape that exactly transforms an incident spherical wave into a plane wave, the terms a and b in equations (2a) through (2d) above are given by the following expressions:

$$\begin{matrix}{a}^{2} = {( \frac{{n}_{2}}{{n}_{1} + {n}_{2}} )}^{2} {r}_{2}^{2} \\ and & ( 3 a ) \\ {b}^{2} = ( \frac{{n}_{1} - {n}_{2}}{{n}_{1} + {n}_{2}} ) {r}_{2}^{2} & ( 3 b )\end{matrix}$$

where n₁ is the refractive index of the core of the hyperbolic lens, n₂ is the refractive index of the medium surrounding the core of the hyperbolic lens, and r 2 is the radius of curvature at the tip of the hyperbolic lens. (Edwards, Christopher A., Presby, Herman M., and Dragone, Corrado. “Ideal Microlenses for Laser to Fiber Coupling.” Journal of Lightwave Technology, Vol 11, No. 2, (1993): 252.) With this hyperbolic profile, the mode field radii at planes (1) and (2), shown in FIG. 1E, are equal, and the radius of curvature at plane (2) is infinity, i.e., the beam wavefront at plane (2) is planar.

Returning to FIG. 1B, for the ideal hyperbolic case described above, if the length of the GRIN lens 106 is quarter pitch, the hyperbolic refractive lens 102 would focus the beam from the multimode pigtail fiber 104 to a diffraction-limited spot. For cases where the length of the GRIN lens 106 is not quarter pitch, the hyperbolic refractive lens 102 would not focus the beam into a diffraction-limited spot because it cannot make all the rays equal at a spot. In accordance with another embodiment of the invention, for cases where the length of the GRIN lens 106 is not quarter pitch, a near-hyperbolic refractive lens is used to produce a diffraction-limited spot. For the near-hyperbolic refractive lens, the curved surface 103 of the refractive lens 102 has a near-hyperbolic profile instead of a hyperbolic profile. The near-hyperbolic lens combines the functions of the hyperbolic lens and a spherical lens to reduce residual beam curvature.

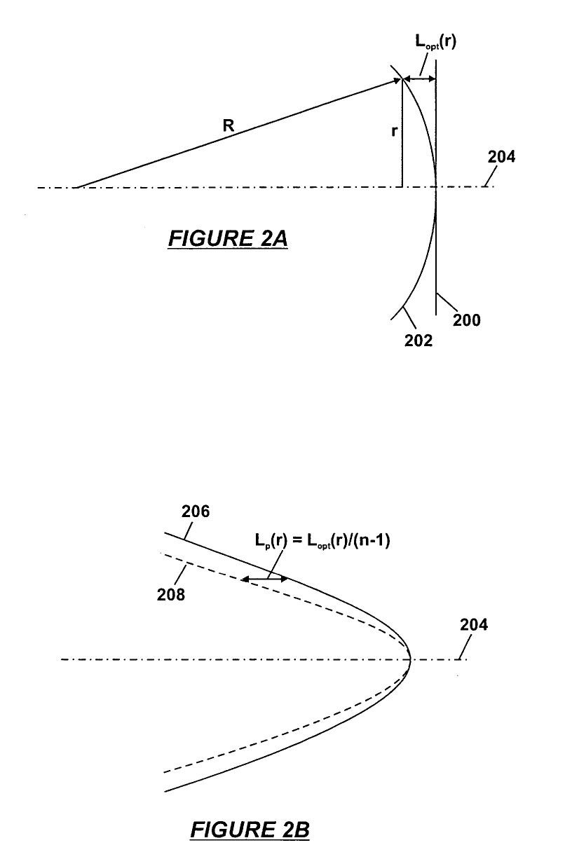

A near-hyperbolic lens profile can be determined with reasonable accuracy by calculating the optical and physical path length changes that need to be made to a hyperbolic profile to compensate for beam curvature. FIG. 2A shows a planar beam wavefront 200, which is produced if the GRIN lens length is at or near quarter pitch, and a diverging beam wavefront 202, which is produced if the GRIN lens length is shorter than quarter pitch. Compared to the optical path length of the planar beam wavefront 200, the optical path length of the diverging beam wavefront 202 is reduced away from the optical axis 204. The optical path length difference, Lₒₚₜ(r), as a function of the radial distance from the optical axis 204 can be calculated using the formula:
Lₒₚₜ(r)=R(1−cos) (4a)
where
φ=sin-⁻¹(r/R) (4b)

The physical path length difference, Lₚ(r), is given by:

$${L}_{p} ( r ) = \frac{{L}_{opt} ( r )}{( n - 1 )} \qquad ( 4 c )$$

where n is the index of the lens material.

The optical path length difference for a GRIN lens length longer than quarter pitch, i.e., a converging beam wavefront, can be calculated using expressions similar to the ones shown above. FIG. 2B shows the schematic of the changes made to a hyperbolic shape 206 to achieve a near-hyperbolic shape 208 that can focus a diverging beam wavefront into a diffraction limited spot. It should be noted that equations (4a)-(4c) only provide one possible method of determining a near-hyperbolic shape. A more accurate near-hyperbolic lens shape can be determined using lens design models.

The shape of the refractive lens 102 may be defined by two curves, e.g., curve C1 in FIG. 1F and curve C2 in FIG. 1G. Curve C1 is formed in a y-plane, while curve C2 is formed in an x-plane. Preferably, curves C1 and C2 are substantially orthogonal to each other and intersect at or near the optical axis of the fiber lens 100. In FIGS. 1F and 1G, the curves C1 and C2 have the same hyperbolic or near-hyperbolic shape and radius of curvature and both define a hyperboloid or near-hyperboloid. However, the invention is not limited to a refractive lens 102 defined by curves C1 and C2 having the same shape and radius of curvature. In general, at least one of the curves C1 and C2 should have a hyperbolic or near-hyperbolic shape while the other curve may have a hyperbolic or near-hyperbolic shape or other shape, such as circular or flat shape. FIG. 1H shows an example where curve C2 has a shape and radius of curvature that is different from that of curve C1 in FIG. 1F. The difference in curvature and shape of the curves C1 and C2, and their substantially orthogonal arrangement with respect to one another, provide an anamorphic lens effect. By controlling the shape and curvature of curves C1 and C2 of the refractive lens 102, the shape of the mode field of the optical signal passed through the refractive lens 102 may be controlled.

Returning to FIG. 1B, the multimode pigtail fiber 104 has a core 112 bounded by a cladding 114. In one embodiment, the characteristics of the multimode pigtail fiber 104 are different from that of the GRIN lens 106. In general, the multimode pigtail fiber 104 differs from the GRIN lens 106 in its core diameter, shape, and/or refractive index profile. In comparison to the GRIN lens 106, the multimode pigtail fiber 104 could be smaller in core diameter and relative index difference between the core and cladding. In addition, the refractive index profile of the multimode pigtail fiber 104 could be graded-index, step-index, or other suitable profile. The overall diameter of the multimode pigtail fiber 104 could be smaller than or substantially the same as that of the GRIN lens 106. Also, the multimode pigtail fiber 104 may be tapered.

It is contemplated that any of the embodiments disclosed in FIGS. 1A-1G can include an additional spacer rod (not shown) disposed between the multimode fiber and the refractive lens either before or after the GRIN lens. These spacer rods are preferably coreless silica glass containing rods, which may be manufactured to have any suitable outside diameter and geometric shape, and which have a uniform or constant index of refraction, and thus little or no lensing characteristics. When employed in the lensing configuration, these spacer rods provide additional design flexibility.

One of the applications of the fiber lens is coupling of light from a pigtail fiber to an optical device or vice versa. FIG. 11 shows an example where the fiber lens 100 is coupling light from a wide stripe multimode laser diode 116 to the pigtail fiber 104. Since there are a number of modes that can be coupled between the optical device, e.g., the laser diode 116, and the multimode pigtail fiber 104, one design requirement is that the working distance of the fiber lens 100 be dictated by the hyperbolic or near-hyperbolic shape of the refractive lens 102. Another design requirement is that the diameter of the core 108 of the GRIN lens 106 be equal to or greater than the size of the mode field at the tip of the refractive lens 102.

The combination of the GRIN lens 106 and the refractive lens 102 allows extreme anamorphic, e.g., generation of highly elliptical shapes from a circular beam or vice versa. This is a significant advantage when coupling with multimode broad band laser diode where emitting areas have dimensions such as 1×100 ∥m. The combination of the refractive lens 102 and the GRIN lens 106 also allows the “x” and “y” focal lengths of the combined lenses to be varied independently, which in turn allows for independent magnification/demagnification along the x- and y-axis of the lens. The fiber lens 100 provides for longer working distances in comparison to a wedge polished multimode pigtail fiber. In FIG. 11, working distance, WD, is the distance between the laser diode 116 and the tip of the fiber lens 100 where coupling efficiency is maximized.

When viewed from an end, the shapes of the core and cladding 112, 114 of the multimode pigtail fiber 104 may be circular or may have another shape appropriate for the target application. For example, for high power pump applications and other high power medical applications, it is advantageous to design the core shape of the multimode pigtail fiber 104 to match the aspect ratio of the pump laser diode to achieve efficient coupling.

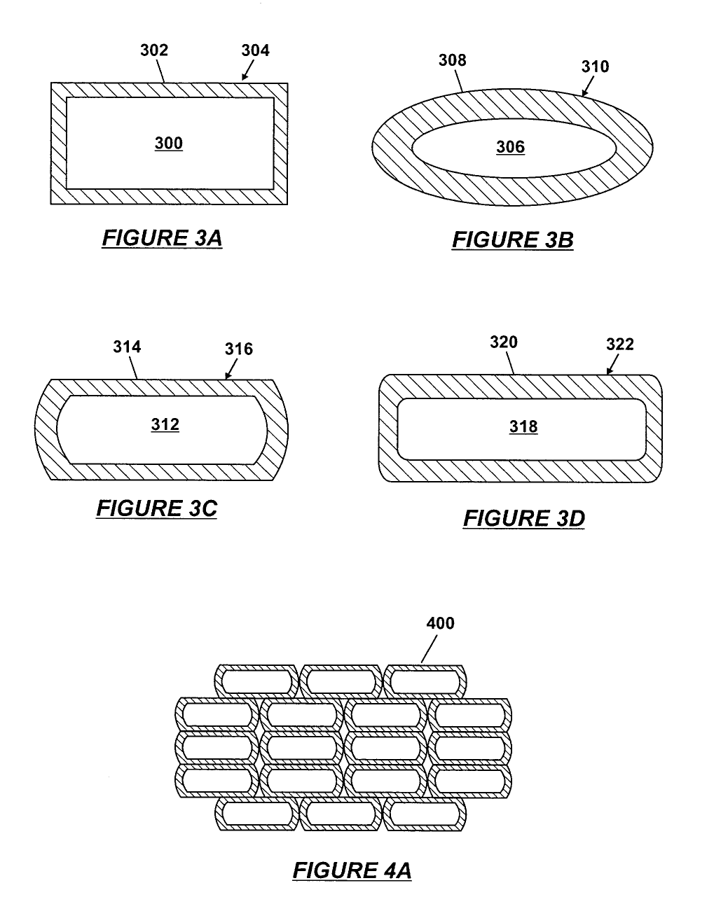

FIGS. 3A-3D show various multimode pigtail fiber cross-sections in accordance with embodiments of the invention. In FIG. 3A, a core 300 and cladding 302 of a multimode pigtail fiber 304 have a rectangular cross-section. In FIG. 3B, a core 306 and cladding 308 of a multimode pigtail fiber 310 have an elliptical cross-section. In FIG. 3C, a core 312 and cladding 314 of a multimode pigtail fiber 316 have a rectangular cross-section with convex end faces. In FIG. 3D, a core 318 and cladding 320 of a multimode pigtail fiber 322 have a rectangular cross-section with rounded corners. The cross-sectional shapes shown in FIGS. 3A-3D have a large aspect ratio and are optimized for coupling and bundling efficiency for high power laser applications. In one embodiment, the aspect ratio, i.e., ellipticity, of the core shapes is in a range from 1 to 10.

The core shapes in FIGS. 3A-3D provide significant advantages when coupling to multimode broad area laser diodes (BALDS) and other high aspect ratio devices. Because the combination of the GRIN lens (106 in FIG. 1B) and the refractive lens ( 102 in FIG. 1B) allows independent design of the x and y focal lengths and demagnifications, it is possible to magnify the image of the very small vertical dimension of the laser diode to a larger value to match the y dimension of the optimized multimode pigtail fiber. This magnification also reduces the divergence angle and numerical aperture of the beam that falls on the multimode pigtail fiber. Hence, the numerical aperture of the multimode pigtail fiber can be much smaller than the vertical numerical aperture of the laser diode. For example, the image can be magnified 5 to 10 times in the vertical direction. In the x- or horizontal direction, the image is demagnified. Thus, for example, the 120-μm horizontal stripe from the laser diode can be imaged to a 100 μm core of the multimode pigtail fiber. This allows an optimized use of the cross-sectional area and the numerical aperture of the pigtail to match that of the laser diode. Minimal cladding dimensions consistent with the process and loss from external contaminants also optimizes the usage of the cross-sectional area of the pigtail.

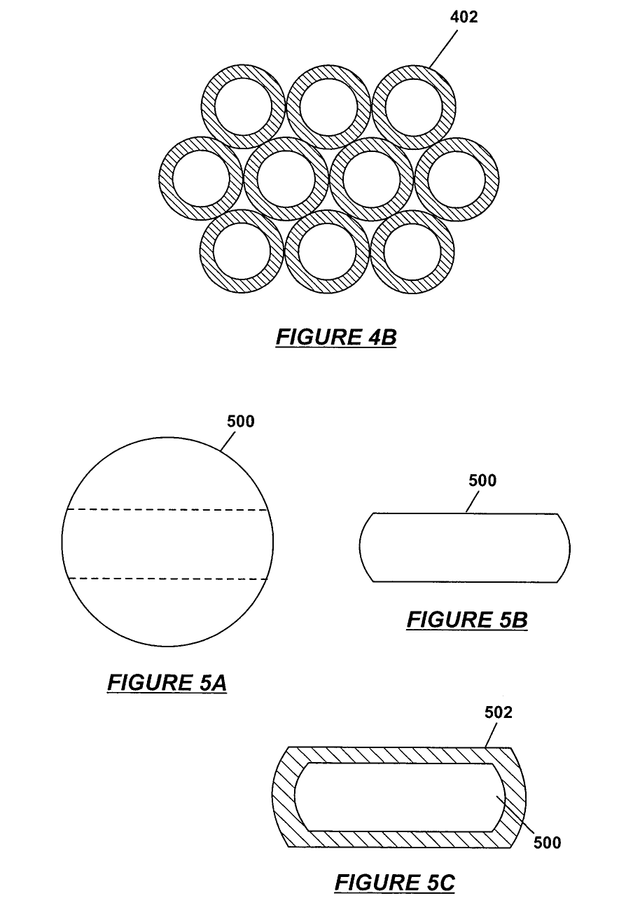

Multimode pigtail fibers having cross-sections such as shown in FIGS. 3A-3D can be effectively bundled without significantly impacting the coupling efficiency of the individual fiber lenses. For example, FIG. 4A shows bundling of pigtail fibers 400 having a cross-section similar to the one shown in FIG. 3C. For comparison purposes, FIG. 4B shows bundling of pigtail fibers 402 having a standard circular cross-section. The horizontal core dimension of the pigtail fibers 400 in FIG. 4A is the same as the horizontal core dimension of the pigtail fibers 402 in FIG. 4B. However, the bundling efficiency of the pigtail fibers 400 in FIG. 4A is better than that of the pigtail fibers 402 in FIG. 4B because the shape and smaller vertical dimension of the pigtail fibers 400 in FIG. 4A reduce the wasted space between the pigtail fibers.

FIGS. 5A-5C illustrate a process of making a pigtail fiber according to an embodiment of the invention. In FIG. 5A, the process starts with a core blank 500 having the required dimensions and index difference and profile. This core blank 500 can be fabricated using a standard blank fabrication technique such as outside vapor deposition process. In FIG. 5B, the core blank 500 is shaped by grinding and polishing to the required shape. In this example, the core blank 500 is shaped to the cross-section shown in FIG. 3C. In general, the core blank 500 could be shaped to any of the cross-sections shown in FIGS. 3A-3D or other appropriate shapes. The core blank 500 is then cleaned to remove any contaminants introduced during the grinding and polishing steps. Such process includes normal cleaning with alcohol, but may also include acid etching, and fire polishing etc. In FIG. 5C, the core blank 500 is overclad with appropriate cladding layer 502 using, for example, an outside vapor deposition process. The core blank 500 with the cladding layer 502 can now be drawn to form the pigtail fiber. To maintain the shape of the blank during the draw operation, the draw temperature should be carefully controlled. It should be noted that some of the steps are not described here in detail as they are standard process steps in the blank making process.

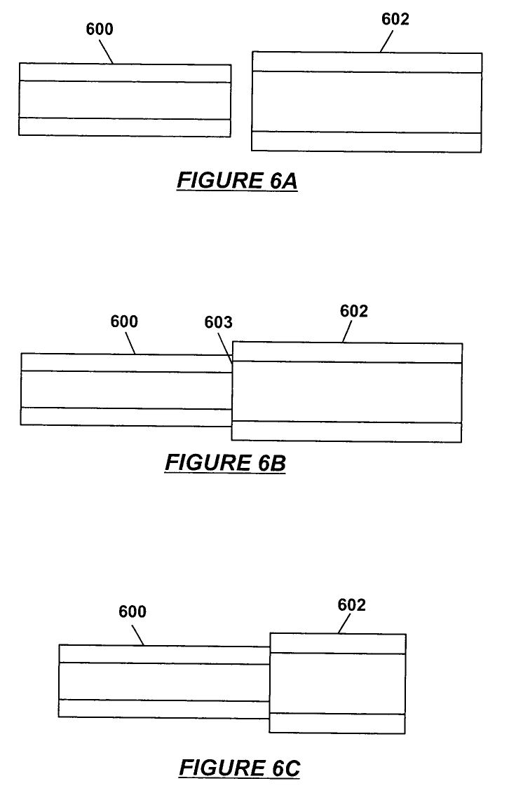

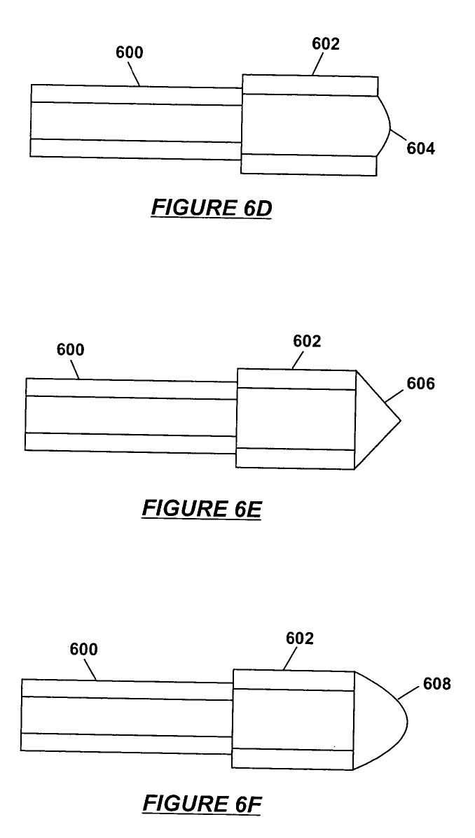

The fiber lens 100 can be fabricated using a fusion splicer such as Vytran 2000 splicer with programmable features or other heat sources with similar control parameters. One example of an alternate heat source is a CO₂ laser. The fabrication involves stripping, cleaning, and cleaving a pigtail fiber and a GRIN fiber and loading the fibers into the splicer. The cleaved angles are preferably within specification. As shown in FIG. 6A, a pigtail fiber 600 and a GRIN fiber 602 are aligned, e.g., in a splicer (not shown). In FIG. 6B, the pigtail fiber 600 is spliced to the GRIN fiber 602. The pigtail fiber 600 and GRIN fiber 602 are then fire-polished. Heat and tension are applied to the GRIN fiber and pigtail fiber as necessary to ensure that the splice junction 603 is straight, i.e., that the optical axis of the pigtail fiber 600 and GRIN fiber 602 coincide. This step is important for removing any misalignments between the pigtail and GRIN fibers 600, 602 and getting the pointing angle of the fiber lens close to zero. In FIG. 6C, the GRIN fiber 602 is taper cut or cleaved to the appropriate length. In FIG. 6D, a pre-melt step is used to put a slight convex shape 604 at the tip of the GRIN fiber 602. The convex shape may help in getting uniform shape and radius properties in the horizontal direction when the tip of the GRIN fiber 602 is shaped into a refractive lens.

In FIG. 6E, the tip of the GRIN fiber 602 is polished or micromachined into a wedge 606 having an apex angle defined by the asymptotes of the desired hyperbolic profile. In FIG. 6F, the wedge 606 is then re-melted to obtain the refractive lens shape which includes a hyperbolic or near-hyperbolic shape 608. The re-melting step includes rounding the wedge 606. The process of polishing and re-melting is iterative. The variables in the recipe development include movement of the stages holding the pigtail and GRIN fibers 600, 602, the heating filament source, the current delivered to the filament, the duration of heating, etc. Using these variables, the recipe is developed so that the tip shape of the GRIN fiber 602 is close to the needed shape. The diagnostics used to characterize this process include not only geometrical characterizations of the lens tip shape, but also the far-field distribution of the output. If needed, re-melt of the lens tip is also done to achieve the needed divergence angles and intensity distributions and working distances.

Instead of forming the refractive lens at the tip of the GRIN fiber, it is also possible to form the refractive lens separately and then affix the refractive lens to the GRIN fiber. It is also possible to splice a fiber having a uniform refractive or a coreless rod to the GRIN fiber and then shape the fiber or rod into the refractive lens. Instead of splicing the GRIN fiber to the pigtail fiber, one end of the pigtail fiber may be shaped into the refractive lens or a separately formed refractive lens may be affixed to the pigtail fiber or a fiber having a uniform refractive index or a coreless rod may be spliced to the pigtail fiber and then shaped into the refractive lens. It is also possible to incorporate a spacer rod between the pigtail fiber and the grin fiber to provide an additional degree of freedom in the object distance between the multimode fiber and the GRIN fiber lens

While the invention has been described in terms of several preferred embodiments, there are alterations, permutations, and equivalents which fall within the scope of this invention. It is therefore intended that the following appended claims be interpreted as including all such alterations, permutations, and equivalents as fall within the true spirit and scope of the invention.

1. A fiber lens, comprising:
a multimode fiber; and
a refractive lens disposed at an end of the multimode fiber to focus a beam from the multimode fiber.

2. The fiber lens of claim 1, wherein the refractive lens is disposed whereby the beam from the multimode fiber is focused into a diffraction-limited spot.

3. The fiber lens of claim 1, wherein the refractive lens has a hyperbolic or near-hyperbolic shape in at least a first plane of the fiber lens, the near-hyperbolic shape having a correction factor that compensates for beam curvature.

4. The fiber lens of claim 3, wherein the refractive lens has a hyperbolic or near-hyperbolic shape in a second plane of the fiber lens orthogonal to the first plane.

5. The fiber lens of claim 4, wherein a radius of curvature of the hyperbolic or near-hyperbolic shape in the second plane is different from a radius of curvature of the hyperbolic or near-hyperbolic shape in the first plane.

6. The fiber lens of claim 3, wherein the refractive lens has a shape other than hyperbolic or near-hyperbolic in a second plane of the fiber lens orthogonal to the first plane.

7. The fiber lens of claim 1, wherein the multimode fiber has a cross-sectional shape with an aspect ratio ranging from approximately 1 to 10.

8. The fiber lens of claim 1, wherein a core of the multimode fiber has a non-circular cross-sectional shape.

9. The fiber lens of claim 8, wherein the non-circular shape is a rectangle.

10. The fiber lens of claim 8, wherein the non-circular shape is a rectangle with rounded corners.

11. The fiber lens of claim 8, wherein the non-circular shape is an ellipse.

12. The fiber lens of claim 8, wherein the non-circular shape is a rectangle with convex end faces.

13. A fiber lens, comprising:
a multimode fiber;
a graded-index lens disposed at an end of the multimode fiber; and
a refractive lens disposed at an end of the graded-index lens, remote from the multimode fiber, to focus a beam from the multimode fiber.

14. The fiber lens of claim 13, wherein the refractive lens is disposed whereby the beam from the multimode fiber is focused into a diffraction-limited spot.

15. The fiber lens of claim 13, wherein the refractive lens has a hyperbolic or near-hyperbolic shape in at least a first plane of the fiber lens, the near-hyperbolic shape having a correction factor that compensates for beam curvature.

16. The fiber lens of claim 15, wherein the refractive lens has a hyperbolic or near-hyperbolic shape in a second plane of the fiber lens orthogonal to the first plane.

17. The fiber lens of claim 16, wherein a radius of curvature of the hyperbolic or near-hyperbolic shape in the second plane is different from a radius of curvature of the hyperbolic or near-hyperbolic shape in the first plane.

18. The fiber lens of claim 15, wherein the refractive lens has a shape other than hyperbolic or near-hyperbolic in a second plane of the fiber lens orthogonal to the first plane

19. The fiber lens of claim 13, wherein the refractive lens and the graded-index lens provide an anamorphic lens effect.

20. The fiber lens of claim 13, wherein the multimode fiber has a cross-sectional shape with an aspect ratio ranging from approximately 1 to 10.

21. The fiber lens of claim 13, wherein a core of the multimode fiber has a non-circular cross-sectional shape.

22. The fiber lens of claim 19, wherein the non-circular shape is a rectangle.

23. The fiber lens of claim 19, wherein the non-circular shape is a rectangle with rounded corners.

24. The fiber lens of claim 19, wherein the non-circular shape is an ellipse.

25. The fiber lens of claim 19, wherein the non-circular shape is a rectangle with convex end faces.

26. The method of claim 13, wherein the graded-index lens has a cross-sectional shape with an aspect ratio ranging from approximately 1 to 10.

27. A method of making a fiber lens, comprising:
cutting a first fiber to a desired length;
forming a wedge at a tip of the first fiber, the wedge having a cross-sectional shape in a first plane of the fiber lens that is defined by asymptotes of a hyperbola; and
rounding a tip of the wedge to form a hyperbolic shape.

28. The method of claim 27, wherein the first fiber is a multimode pigtail fiber.

29. The method of claim 27, further comprising splicing a multimode pigtail fiber to the first fiber.

30. The method of claim 29, wherein the first fiber is a coreless rod.

31. The method of claim 29, wherein the first fiber is a graded-index fiber.

32. The method of claim 29, wherein a cross-sectional shape of the wedge in a second plane of the fiber lens orthogonal to the first plane is defined by asymptotes of a hyperbola.

33. The method of claim 27, wherein a cross-sectional shape of the wedge in a second plane of the fiber lens orthogonal to the first plane is different from the cross-sectional shape of the wedge in the first plane.

34. The method of claim 27, further comprising adjusting a radius of curvature of the hyperbolic shape to form a near-hyperbolic shape having a correction factor that compensates for beam curvature.

35. The method of claim 27, further comprising forming a convex shape at a tip of the first fiber prior to forming a wedge at the tip of the first fiber.

36. The method of claim 27, wherein forming a wedge at the tip of the first tip comprises polishing or micromachining the tip of the first fiber.

37. The method of claim 27, wherein rounding the tip of the wedge comprises melting and polishing the tip of the wedge.

38. The method of claim 29, wherein the multimode pigtail fiber is made by a process comprising:
shaping a core blank having a desired refractive index to a desired cross-sectional shape;
forming a cladding on the core blank; and
drawing the core blank and the cladding to form the pigtail fiber.

39. The method of claim 38, wherein shaping the core blank includes grinding and polishing the core blank to form the desired cross-sectional shape.

40. The method of claim 38, wherein forming the cladding includes depositing cladding material on the core blank using an outside vapor deposition process.
